(19) United States
(12) Patent Application Publication
(10) Pub. No.: US 2007/0089767 A1
(43) Pub. Date: Apr. 26, 2007

(54) Substrate cleaning apparatus

(76) Inventor: Yoshiharu Yamamoto, Shiga (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/585,136

(22) Filed: Oct. 24, 2006

(30) Foreign Application Priority Data
Oct. 25, 2005 (JP) 2005-309597
Sep. 15, 2006 (JP) 2006-250697

(51) Int. Cl. B08B 3/00

(52) U.S. Cl. 134/149; 134/137

(57) ABSTRACT

An apparatus for cleaning a whole substrate by ejecting a cleaning liquid from a nozzle while rotating the substrate, the apparatus comprising: two or more linear reciprocating driving sources capable of generating outputs independently of one another; a rotation shaft; two or more cam mechanisms for converting the outputs into rotating forces; two or more sets of rotation columns fixed to the rotation shaft rotatably about their respective axes to horizontally support the substrate and sandwich or release the side surface of the substrate in cooperation with one another along with their rotation; two or more transfer members capable of transferring the rotating force to the sets of rotation columns in conjunction with the cam mechanisms, respectively; and a stopper causing the rotation of the cam mechanisms to be related to the rotation of the rotation shaft.

### TECHNICAL FIELD

The present invention relates to an apparatus capable of cleaning the surface, the back surface and the outer peripheral surface of a substrate and can be preferably used for cleaning a precision substrate, such as a semiconductor substrate, a liquid crystal glass substrate, a mask substrate.

### BACKGROUND ART

As an apparatus for cleaning a substrate, there has been conventionally known an apparatus as illustrated in FIG. 11 (for example, JP-A No. 8-299918). The apparatus 101 basically includes a table 102 for holding a substrate 150 by sucking the back surface thereof with a vacuum pump which is not illustrated, a motor 125 for rotating the table 102 with respect to the apparatus main body, and a cleaning-liquid ejecting nozzle which can be revolved above the table 102.

Further, a cleaning liquid is ejected from the ejection nozzle for cleaning the surface of the substrate 150, while the ejection nozzle is reciprocated in the radial direction of the table 102 with respect to the substrate 150 being rotated along with the table 102. During the cleaning, the substrate 150 is surrounded by a cover 110, thereby preventing the cleaning liquid from scattering. When the back surface is cleaned, the evacuation is temporarily stopped, and an operator reverses the substrate 150 with his or her power using gloves, or extracts the substrate 150 on a carrying-out table 161, reverses it with a reversing device (for example, JP-A No. 2003-7663), then introduces it into the apparatus main body on a carrying-in table 160 and performs the cleaning operation, again. When carrying out and carrying in, the cover 110 is pushed up to the upper withdrawal position with an air cylinder 131.

As another conventional apparatus for cleaning a substrate, there has been suggested an apparatus which holds a substrate at the peripheral edge of a table having a center concave portion, places a lower nozzle within the concave portion and supplies a cleaning liquid to the lower nozzle through a pipe passing through the rotation shaft of the table (JP-A No. 11-156314). This apparatus can clean the back surface of the substrate with the cleaning liquid ejected from the lower nozzle, thereby eliminating the necessity of reversing the substrate. Further, although JP-A No. 11-156314 describes no means for securing the substrate on the table, it can be perceived, from the configuration illustrated in the figure, that the peripheral edge of the substrate is held by the table at plural positions individually.

Both the apparatuses employ, in order to dry the substrate after cleaning, a method of increasing the rotation speed to about three times the rotation speed during cleaning for throwing off the cleaning liquid or, in some cases, employ a method of ejecting an alcohol such as isopropyl alcohol (IPA) to the substrate for reducing the drying time.

However, in performing cleaning, the conventional cleaning apparatus illustrated in FIG. 11 requires a longer time period to reverse the substrate 150, thereby reducing the cleaning efficiency. Further, since the apparatus temporarily stops the rotation of the substrate before reversing it, in the case where the substrate is a printed circuit board, a conductive material may be scattered due to the pressure of the cleaning liquid and adhered to the surface and the back surface of the substrate, thereby contaminating the substrate, during the stoppage of the substrate. In the case where the conductive material is made of a low-resistance material such as copper, even a small amount of such a conductive material adhered to the substrate may induce short-circuits between wirings, thus reducing the yield of products. Further, it is difficult to clean the outer peripheral surface of the substrate. The apparatus disclosed in JP-A No. 11-156314 holds the peripheral edge of the substrate with the table at plural positions individually, which makes it difficult to attach or detach the substrate to or from the table.

Next, regarding drying, when the aspect ratios of wiring trenches (grooves) are larger, water marks or IPA may be left in the trenches, which may cause corrosion or contamination of the conductive material, thereby increasing the electric resistances. In some cases, secondary contaminations may occur due to robot hands and the like. This makes it necessary to provide sufficient measures for preventing combustion of the alcohol.

### DISCLOSURE OF THE INVENTION

Therefore, it is an object of the present invention to provide an apparatus capable of cleaning the outer peripheral surface of a substrate while rotating the substrate. It is another object to provide an apparatus capable of cleanly drying a substrate after cleaning of the substrate.

In order to attain the objects, according to the present invention, there is provided an apparatus for cleaning a substrate by ejecting a cleaning liquid from a nozzle while rotating the substrate, wherein the cleaning apparatus comprises a main body, two or more linear reciprocating driving sources capable of generating outputs independently of one another, a rotation shaft rotatably mounted to the main body, two or more cam mechanisms, two or more sets of rotation columns, two or more transfer members and a stopper.

The cam mechanisms are mounted to the main body such that they are rotatable about the rotation shaft and convert the aforementioned outputs into rotating forces. The rotation columns have respective axes parallel to the rotation shaft at positions radially spaced from the center of the rotation shaft and are fixed to the rotation shaft rotatably about their axes to horizontally support a substrate and sandwich or release the side surface of the substrate in cooperation with one another, along with rotation thereof. The transfer members have a rotation center which is concentric with the rotation shaft and transfer the aforementioned rotating forces to the sets of the rotation columns in conjunction with the cam mechanism. The stopper is secured to the rotation shaft and causes the rotation of the cam mechanism to be related to the rotation of the rotation shaft.

The apparatus according to the present invention has effects as follows. At first, a substrate is supported by the rotation columns and is sandwiched by one set of rotation columns (which is referred to as a set A and another set is referred to as a set B), out of the plural sets of rotation columns, while the rotation shaft is rotated. Consequently, the substrate is rotated, thereby enabling cleaning the substrate by ejecting a cleaning liquid thereto. At this stage, it is possible to clean the whole substrate except for the portions of the outer peripheral surface of the substrate which are in contact with the set A of the rotation columns. During this time, the transfer members and the cam mechanisms are also rotated together with the rotation shaft along with the stopper and, also, the respective rotation columns are revolved about a center axis which passes through the rotation shaft.

Next, an output is generated from a driving source to rotate the set B of rotation columns through one of the cam mechanisms and one of the transfer members along a transfer path from the driving source to the set B of the rotation columns. Namely, the cam mechanism converts the output of the driving source into a rotating force and the rotating force is transferred to the set B of rotation columns through the transfer member. Along therewith, the set B of rotation columns being revolved are rotated about their axes. This causes the substrate to be sandwiched by the set B of rotation columns as well as the set A of rotation columns.

Thereafter, the direction of the output from another driving source is changed to rotate the set A of rotation columns about their axes. Consequently, the substrate is released from the set A. This enables cleaning the portions which have been contacted with the set A of rotation columns and thus have been left uncleaned.

The aforementioned rotation columns may include a column having an upper surface, and a pin which is erected at a decentered position on the upper surface and is brought into contact with the side surface of the substrate or separated therefrom along with the rotation of the column, because the bottom surface of the substrate can be supported by the upper surfaces of the columns while the side surface of the substrate can be sandwiched by the pins or released therefrom without damaging the side surface. In this case, the respective sets of pins are placed, such that the pins constituting each set are placed at substantially even intervals in the circumferential direction and are placed at phase positions different from the other sets of pins. Consequently, the respective sets of pins can alternately sandwich or release the substrate. In this configuration of the rotation columns, it is preferable that the aforementioned upper surfaces are inclined and the aforementioned decentered positions are the highest positions on the upper surfaces. This causes the upper surfaces to be contacted with the bottom surface of the substrate in a point-to-point contact, which allows the cleaning liquid to easily pass between the upper surfaces and the bottom surface of the substrate, thereby further improving the cleaning effect.

The means for transferring the rotating force from the transfer members may be gear transmission and belt transmission. It is desirable to employ gear transmission, namely it is desirable to form gear teeth on the outer peripheral surfaces of the aforementioned rotation columns and form gear teeth on the outer peripheral surfaces of the transfer members such that these gear teeth are engageble with each other.

The aforementioned cam mechanisms may be combinations of a grooved cam having a groove inclined with respect to the rotation shaft which is mounted rotatably with respect to the main body and movably in the direction of the rotation shaft and a roller which rotates within the groove and is secured to the corresponding transfer member. Since the groove is inclined with respect to the rotation shaft, the movement of the grooved cam in the direction of the rotation shaft displaces the roller in the circumferential direction, thereby rotating the transfer member.

The aforementioned stopper may be a disk member which is orthogonal to the rotation shaft and has concave portions which allow the grooved cams to move in the direction of the rotation shaft and cause the grooved cams to rotate together with the rotation shaft.

It is preferable that a table is secured to the upper end of the aforementioned rotation shaft and the aforementioned rotation columns are hermetically secured to the rotation shaft through the table, because components under the table can be prevented from being wetted. Further, it is preferable that the table extends outwardly in the radial direction from the rotation columns and there is provided a cover which can be hermetically contacted with the upper surface of the extended portion of the table and can house the rotation columns. This can house the substrate within an extremely narrow sealed space. This enables rapidly drying the substrate while halting the substrate at the position, by combining depressurization means and means for introducing a gas inert to the substrate material. Further, such a hermetic sealing configuration using a table and rotation columns can be applied to cleaning apparatus having, under a table, power transfer mechanisms different from that of the present invention.

Namely, in order to attain the aforementioned second object, a preferable substrate drying apparatus includes a table, plural supporting columns erected between the center of the table and the peripheral edge thereof for supporting a substrate (in the case where the aforementioned cleaning apparatus is a compound apparatus which also serves as the drying apparatus, the rotation columns form the supporting columns), a cover which can be hermetically contacted with the upper surface of the table to house the supporting columns and is movable in such a direction that it is separated from the table, and means for depressurizing the space surrounded by the cover which is contacted with the table and the table.

The substrate cleaning apparatus according to the present invention can clean an entire substrate including its outer peripheral surface while rotating the substrate. This can alleviate adhesion of a conductive material scattered due to the pressure of the cleaning liquid to the substrate, thereby improving the cleanliness of the cleaned substrate. Further, the entire apparatus has a smaller size, since there is provided no reversing/transferring devices for cleaning the surface and the back surface of a substrate.

### BRIEF DESCRIPTION OF THE DRAWINGS

FIG. 1 is an axial cross-sectional view illustrating a cleaning apparatus according to a first embodiment.

FIG. 2 is a plan view illustrating main bodies of the same cleaning apparatus.

FIG. 3 is a front view illustrating a grooved cam in the same cleaning apparatus.

FIGS. 4A and 4B are a plan view and a front view illustrating the relationship between a grooved cam and a stopper in the same cleaning apparatus, respectively.

FIGS. 5A and 5B are a plan view and a rear view illustrating the relationship between another grooved cam and the stopper in the same cleaning apparatus, respectively.

FIG. 6 is a plan view illustrating a transfer member in the same cleaning apparatus.

FIG. 7 is a plan view illustrating another transfer member in the same cleaning apparatus.

FIG. 8 is a view illustrating the timing of rotations of a set of rotation columns and another set of rotation columns.

FIG. 9 is an axial cross-sectional view illustrating a cleaning apparatus according to a second embodiment.

FIG. 10 is an enlarged view of the portion D in FIG. 9.

FIG. 11 is an axial cross-sectional view illustrating main parts of a conventional cleaning apparatus.

FIG. 12 is an axial cross-sectional view illustrating a modified example of the cleaning apparatus according to the first embodiment.

FIG. 13 is an axial cross-sectional view illustrating a modified example of the cleaning apparatus according to the second embodiment.

### DETAILED DESCRIPTION OF THE PREFERRED EMBODIMENTS

Embodiments of the present invention will be described with reference to the drawings.

### First Embodiment

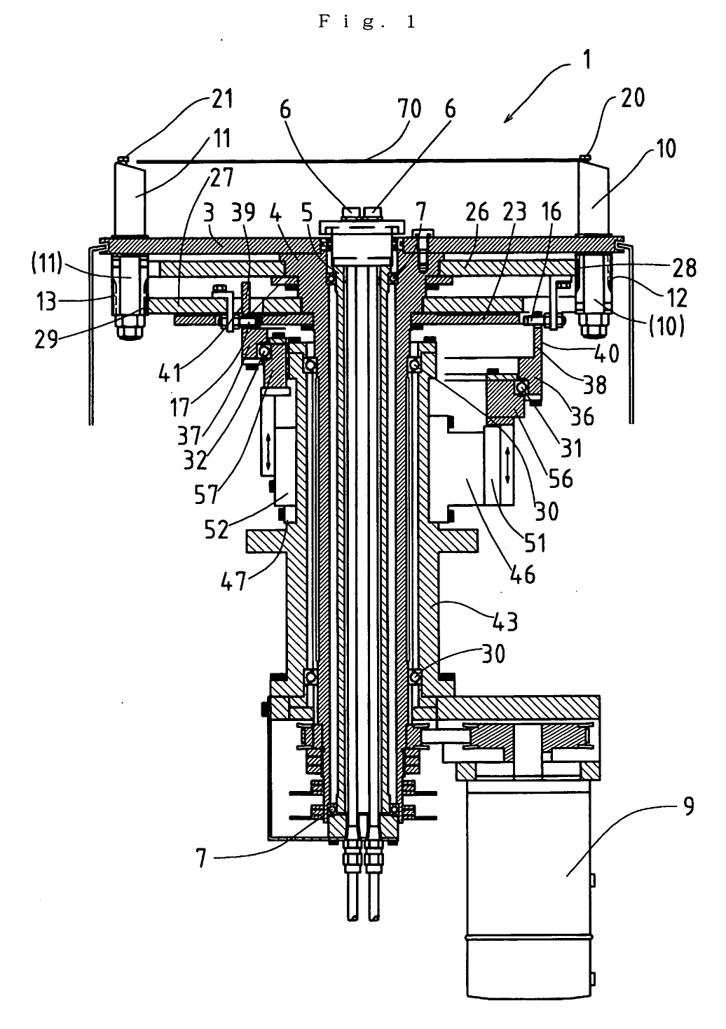

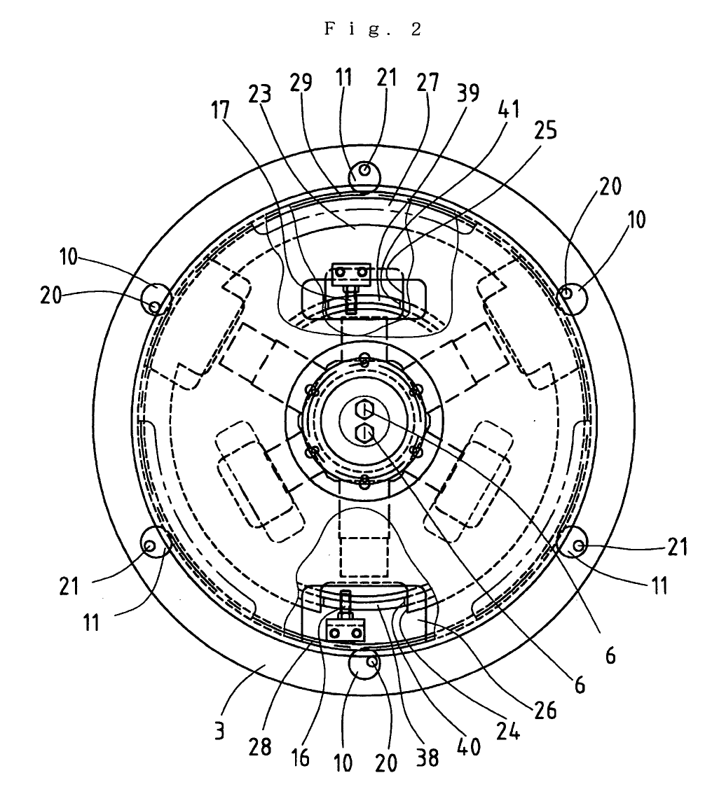

FIG. 1 is an axial cross-sectional view illustrating a cleaning apparatus according to a first embodiment and FIG. 2 is a main-part plan view of the same.

The cleaning apparatus 1 is configured to eject a cleaning liquid while rotating a semiconductor substrate 70 to clean the semiconductor substrate 70. The cleaning apparatus 1 includes a main body 43 having a cylindrical portion, a driving motor 9 secured to the main body 43, a hollow rotation shaft 4 mounted via upper and lower bearings 30 to the inner peripheral surface of the cylindrical portion of the main body 43, three reciprocating air cylinders 51 secured through a cylinder base 46 to the main body 43 at even intervals in the circumferential direction, and three reciprocating air cylinders 52 similarly secured through a cylinder base 47. The driving motor 9 rotates the rotation shaft 4 about its axis through a belt. A disk-shaped table 3 is fastened to the upper end of the rotation shaft 4 with bolts. A center shaft 5 is fitted within the rotation shaft 4 through upper and lower bearings 7, and two cleaning-liquid supply pipes are passed through the center shaft 5. The center shaft 5 is protruded upwardly from the table 3, and two lower nozzles 6 connected to the respective supply pipes are mounted to the upper end of the center shaft 5, and the lower end of the center shaft 5 is secured to the main body 43.

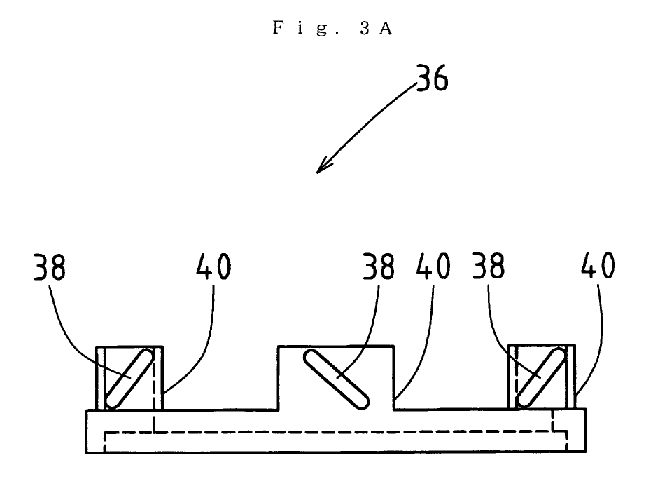

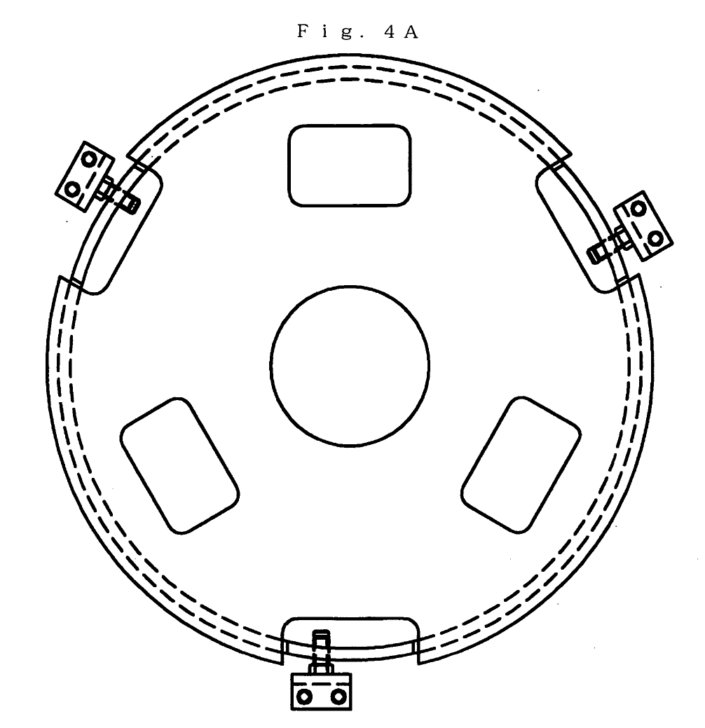

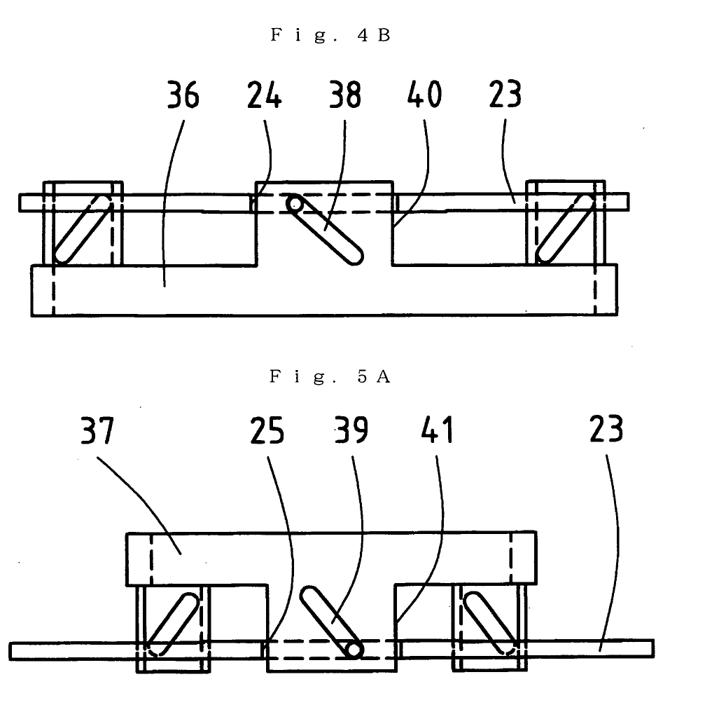

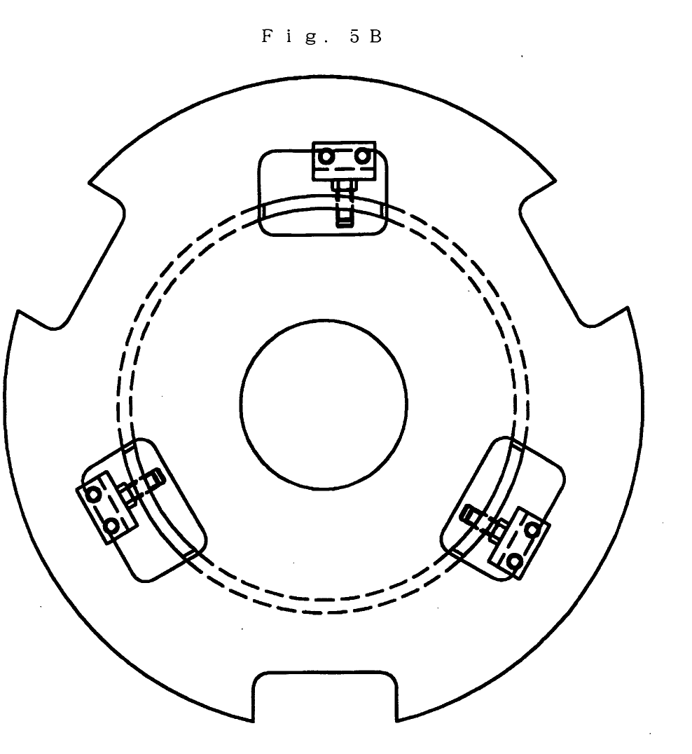

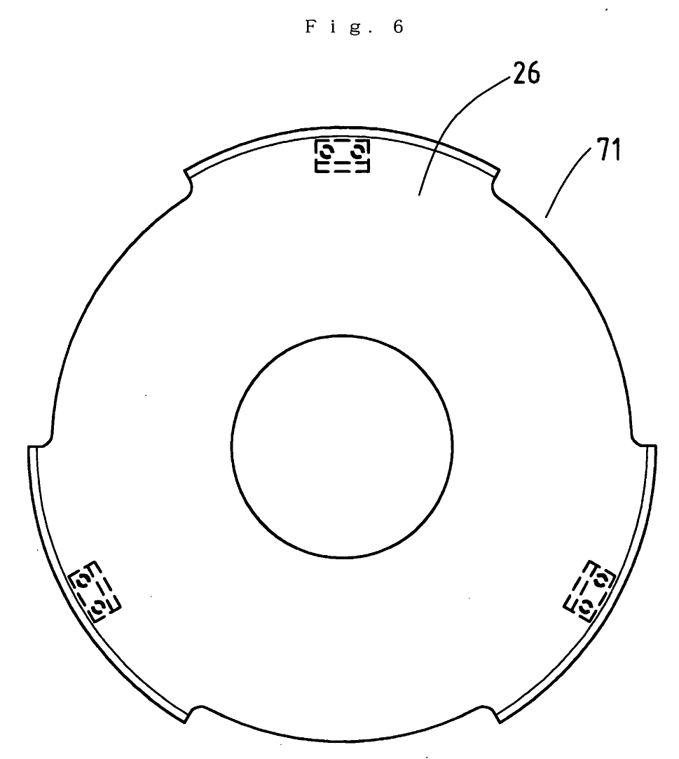

The two sets of air cylinders 51 and 52 include rods which reciprocate in the upward and downward directions along with blocks 56 and 57 provided at their tip ends and are connected to a control device, which is not illustrated, such that the cylinders constituting each set operate in synchronization with one another and generate outputs independently of the other set of cylinders. An annular grooved cam 37 surrounding the cylindrical portion of the main body 43 is mounted to the block 57 through a bearing 32, while another annular grooved cam 36 is mounted to the block 56 through a bearing 31 such that it surrounds the grooved cam 37. Namely, the grooved cams 36 and 37 are placed in a double ring shape in a non contact manner. As illustrated in a front view of FIG. 3, three upward protrusions 40 are formed on the peripheral edge portion of the grooved cam 36 at even intervals in the circumferential direction and, further, protrusions 41 are formed on the peripheral edge portion of the grooved cam 37 at positions deviated in phase by 60 degrees from the protrusion 40. Further, grooves 38 and 39 are radially formed through the protrusions 40 and 41, wherein the grooves 38 and 39 are inclined in an upward-and-leftward direction when viewed from the outside. The inclination of the groove 38 is smaller than the inclination of the groove 39, in order to make the rotation stroke of a transfer member 26 which will be described later equal to the rotation stroke of a transfer member 27. Above the grooved cams 36 and 37, a disk-shaped stopper 23 having an outer diameter greater than that of the grooved cam 36 is protruded in the radial direction from the outer peripheral surface of the rotation shaft 4. The stopper 23 is fastened to the rotation shaft 4 with bolts. The stopper 23 has cutouts 24 and holes 25 for receiving the protrusions 40 and 41 with slight clearance at the positions corresponding to the protrusions 40 and 41, as illustrated in FIGS. 4A, 4B, 5A and 5B. This allows upward and downward movements of the grooved cams 36 and 37 and also prevents the rotations of the grooved cams 36 and 37 relative to the rotation shaft 4.

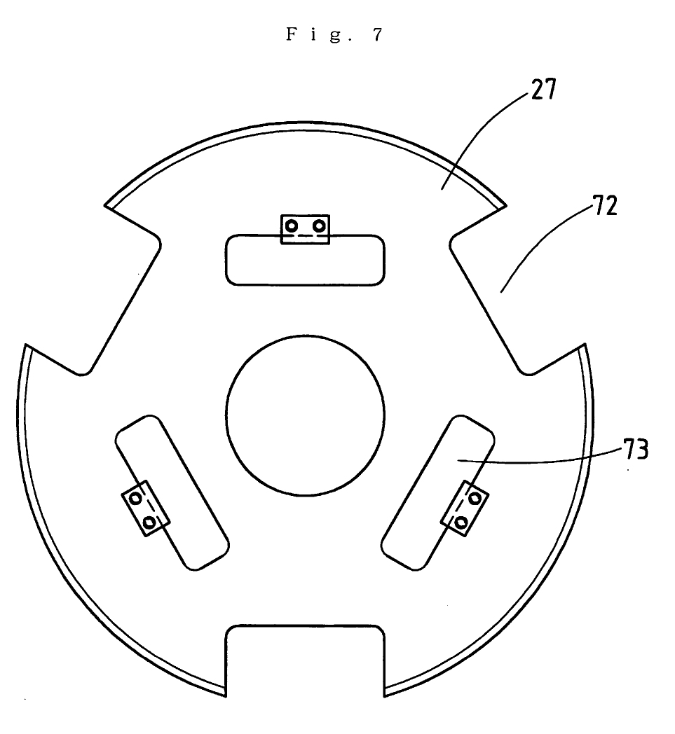

On the other hand, three rotation columns 10 are mounted to the peripheral edge of the table 3 at even intervals in the circumferential direction and, further, rotation columns 11 are mounted to the same periphery at positions deviated in phase by 60 degrees from the rotation columns 10. The three rotation columns 10 have the same shape. This also applies to the rotation columns 11. The rotation columns 10 and 11 are rotatably penetrated through the table 3 in the vertical direction. Further, the upper surfaces of the rotation columns 10 and 11 are inclined with moderate gradients, and round-bar-shaped pins 20 and 21 are upwardly protruded at substantially highest positions of the upper surfaces. Gears 12 and 13 are fitted and secured to the rotation columns 10 and 11 at their portions under the table 3. These gears 12 and 13 are engaged with gear teeth 28 and 29 formed on the outer peripheral surfaces of the transfer members 26 and 27, respectively. The transfer members 26 and 27 have substantially a disk shape having an axial hole at the center, as illustrated in plan views of FIGS. 6 and 7. The transfer member 26 is made of a resin having a low friction coefficient such as a fluororesin and is slidably fitted to the outer peripheral surface of the rotation shaft 4 at a position just under the table 3. The transfer member 27 is similarly fitted to the rotation shaft 4 at a position lower than the transfer member 26. Further, the transfer members 26 and 27 are provided with concave-shaped relieves 71 and 72, in order to prevent the transfer members 26 and 27 from interacting with the gears 13 and 12 which are not to be engaged therewith. Further, near the lower surfaces of the transfer members 26 and 27, rollers 16 and 17 are mounted through brackets such that they are rotatable within the grooves 38 and 39 of the grooved cams. Further, the reference character 73 in FIG. 7 designates holes for inserting the brackets therethrough.

Above the table, there is provided an upper nozzle (not illustrated). The upper nozzle is similar to an ejecting device 30 disclosed in WO2005-38893, for example, and is held at an end portion of an arm, wherein the other end of the arm is connected to a joint such that it is rotatable about a horizontal axis, and the joint is rotatably erected on the main body. Accordingly, the upper nozzle can be moved in the horizontal direction and also can be inclined and is capable of ejecting the cleaning liquid toward the upper surface and the side surfaces of the substrate.

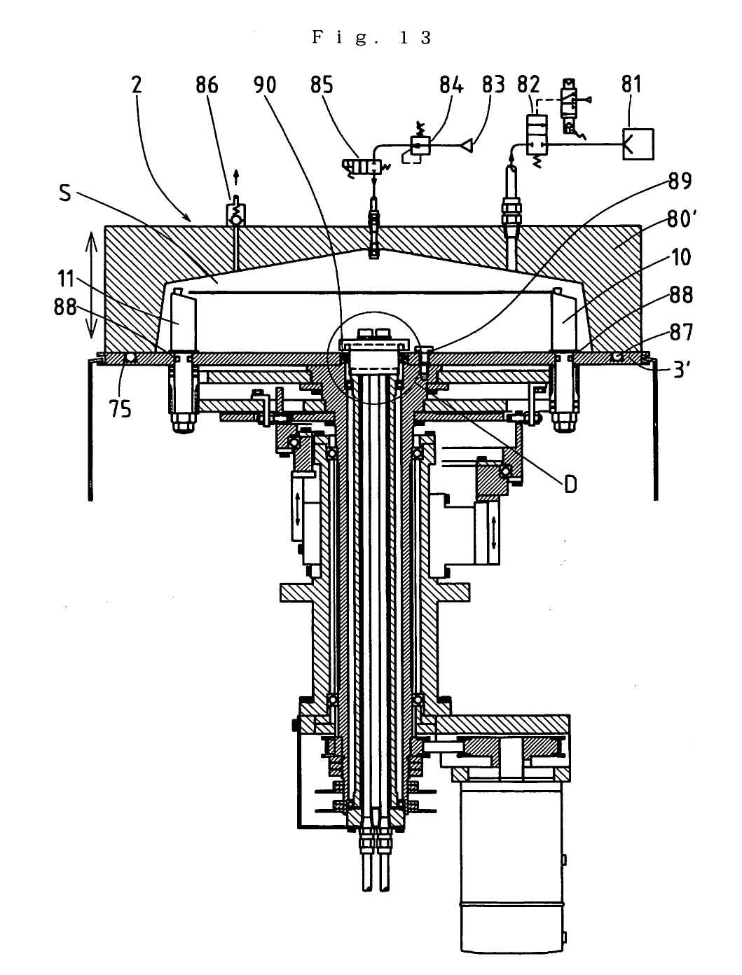

Further, as illustrated in an axial cross-sectional view of FIG. 12, the transfer members 26 and 27 can be engaged with the rotation shaft 4, with ball-and-roller bearings 60 and 61 interposed therebetween.

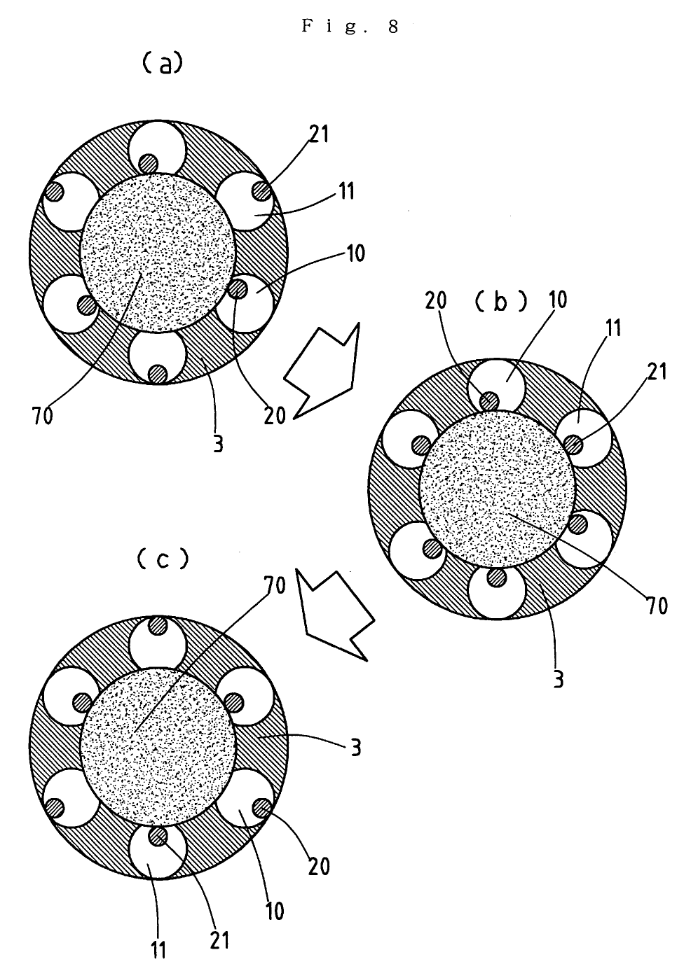

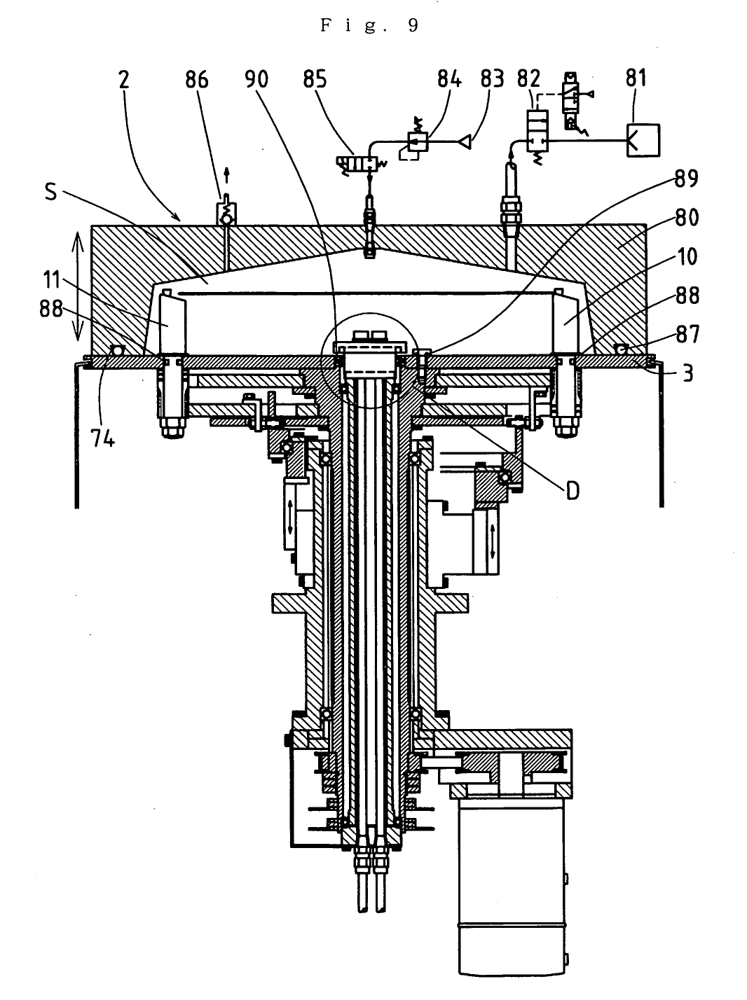

There will be described the operation for cleaning a circular substrate 70 using the cleaning apparatus 1. In the following description, the terms “clockwise direction” and “counter clockwise direction” refer to “the clockwise direction in a plan view” and “the counter clockwise direction in a plan view”, respectively. The substrate 70 is placed on the upper surfaces of the rotation columns 10 and 11, while the motor 9 is kept at an OFF state, the rotation of the table 3 is kept stopped and the pins 20 and 21 are kept withdrawn outwardly from the outer peripheral surface of the substrate 70. Then, the block 56 is lowered. This causes the grooved cam 36 to be lowered along with the block 56. FIGS. 4A and 4B illustrate a state where the grooved cam 36 has been lowered. While the grooved cam 36 tries to rotate in the direction of the groove 38 during the lowering due to the reaction force from the rollers 16, the stopper 23 prevents the rotation of the cam 36 by means of the engagement between the protrusions 40 and the cutouts 24. Accordingly, on the contrary, the rollers 16 are moved in the clockwise direction while rotating within the groove 38 during the lowering of the grooved cam 36 and, along therewith, the transfer member 26 is rotated in the same direction. This causes the three rotation columns 10 to be concurrently rotated in the counter clockwise direction, thereby causing the three pins 20 to sandwich the outer peripheral surface of the substrate 70 (FIG. 8(a)). As a result, the substrate 70 is held by the set of the three rotation columns 10 in such a manner as to maintain the center of the table 3 and that of the substrate 70 coincident with each other.

At this state, the motor 9 is driven to cause the substrate 70 to rotate together with the rotation shaft 4 and the table 3, while a cleaning liquid is ejected from the upper and lower nozzles. Consequently, the substrate 70 is cleaned substantially over its entire surface, except the portions thereof which is in contact with the pins 20. During this time, the transfer members 26 and 27 and the grooved cams 36 and 37 are accompanied by the stopper 23 and rotated together with the rotation shaft 4, and the respective rotation columns 10 and 11 are also revolved about the center shaft 5.

Next, the block 57 is lowered by means of the cylinder 52. Then, during lowering the block 56, the grooved cam 37 is lowered from the ascent position of FIG. 1 in the same way of lowering the grooved cam 36, and the transfer member 27 is rotated in the clockwise direction along with the rotation of the rollers 17. This causes the rotation columns 11 being revolved to be rotated in the counter clockwise direction, thereby causing the three pins 21 to sandwich the outer peripheral surface of the substrate 70. As a result, the substrate 70 is held by the sets of rotation columns each set being constituted by three rotation columns, namely a total of six rotation columns, without stopping the rotation of the substrate 70 (FIG. 8(b)).

Thereafter, the block 56 is lifted by means of the cylinder 51 along with the grooved cam 36. This causes the transfer member 26 to be rotated in the counter clockwise direction, thereby causing the rotation columns 10 being revolved to be concurrently rotated in the clockwise direction. Consequently, the three pins 20 are separated from the substrate 70 (FIG. 8(c)), thereby allowing its portions which have been contacted with the pins 20 to be cleaned.

The cylinders 51 and 52 can be either push-type cylinders or pull type cylinders. In any of the cases, it is preferable to use return springs in combination therewith, in order to enable lowering the blocks 56 and 57 even in the event of stoppage of air supply due to a power failure, air leakage and the like. Further, while the numbers of the cylinders 51 and 52, the protrusions 40 and 41 and the rollers 16 and 17 provided therein are all three, in order to reduce the bending moments to reduce the distortions generated in the grooved cams, the rollers and the transfer members, the numbers of them are not limited. The rotation columns 10 and 11 can have horizontal upper surfaces, but it is preferable that their upper surfaces are inclined. When their upper surfaces are inclined, the substrate 70 is supported by the rotation columns 10 and 11, in a point-to-point contact. This allows the cleaning liquid to easily pass between the bottom surface of the substrate 70 and the rotation columns 10 and 11, thereby increasing the cleaning ability. It is not necessary that the geometrical center of the table 3 is coincident with the rotation center thereof and, in the case where they are not coincident with each other, it is possible to clean the entire surface including the geometrical center more evenly. In order to make the geometrical center incoincident with the rotation center, one of the three rotation columns 10 (and 11) can be engaged with the transfer member 26 (and 27) such that it precedes or delays from the other two rotation columns by a tooth or two teeth.

### Second Embodiment

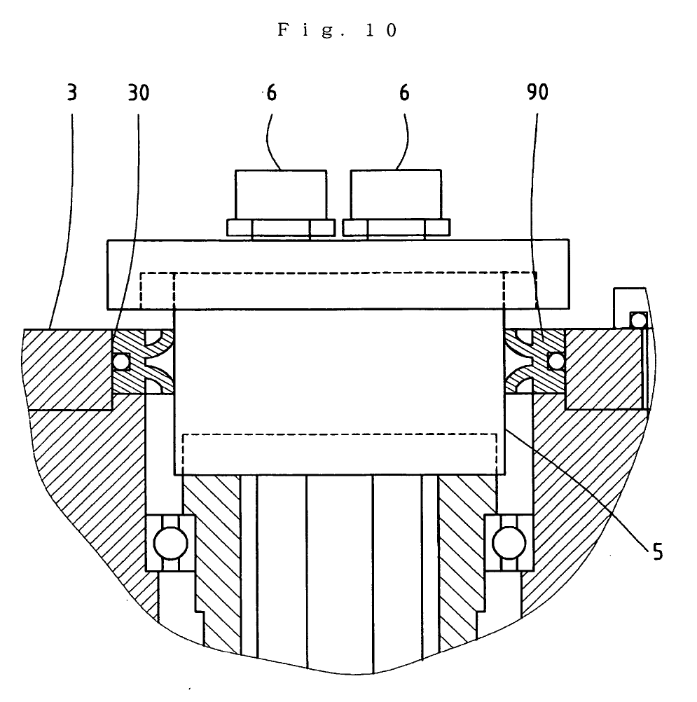

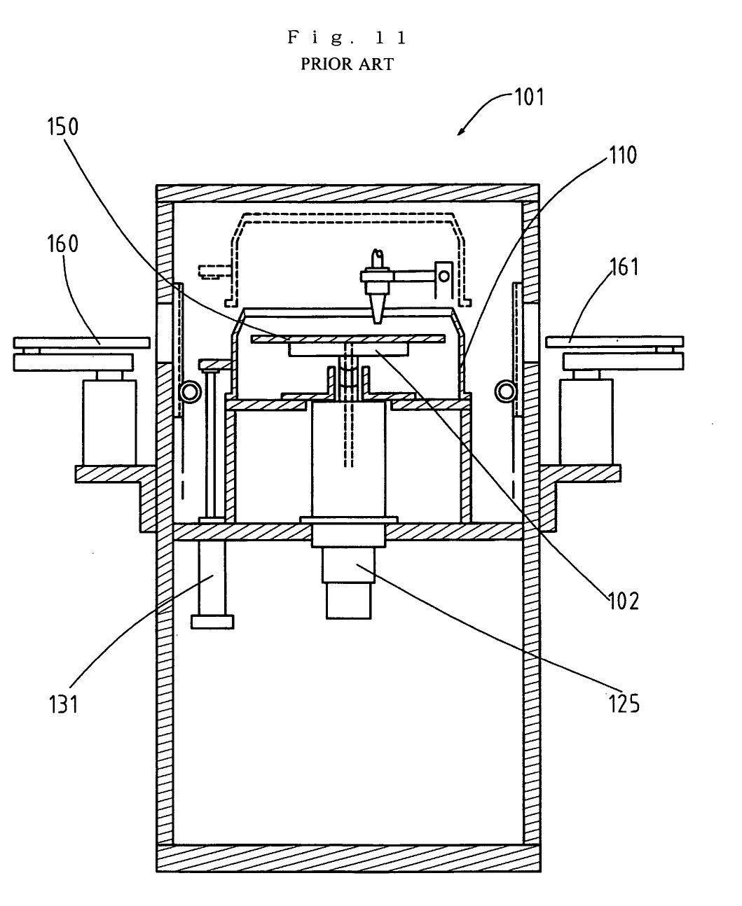

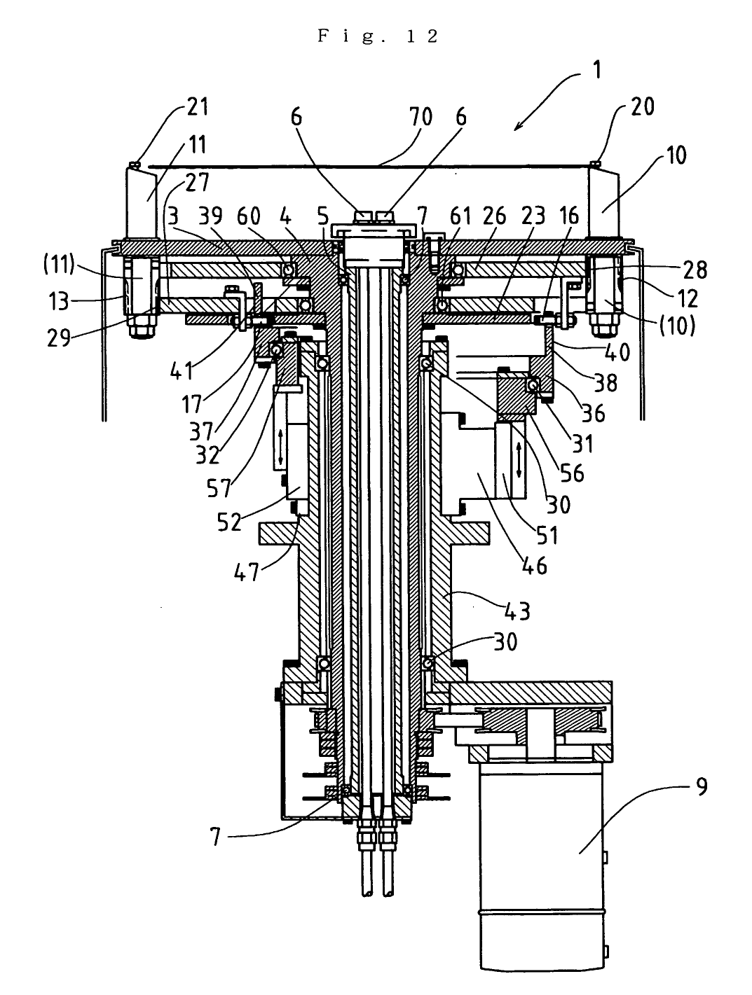

FIG. 9 is an axial cross-sectional view illustrating a substrate cleaning apparatus according to a second embodiment. FIG. 10 is an enlarged view of the portion D in FIG. 9. The cleaning apparatus according to the present embodiment enables drying a substrate without moving the substrate, after cleaning. The cleaning apparatus 2 can have the same configuration as that of the first embodiment, under the table 3. Hereinafter, there will be described, in detail, differences from the first embodiment and portions which were not described in the first embodiment.

In the present embodiment, a cup-shaped cover 80 capable of housing the rotation columns 10 and 11 is provided on the upper surface of the table 3 such that it is hermetically contacted with the upper surface. The cover 80 can be hoisted and lowered by means of a hoisting apparatus which is not illustrated. Ring seals 88 made of a rubber or a fluororesin are fitted around the outer peripheral surfaces of the rotation columns 10 and 11. O-ring seals 89 are similarly fitted around the outer peripheral surfaces of bolts with which the table 3 is fastened to the rotation shaft 4. Further, as illustrated in FIG. 10, a ring seal 90 made of a fluororesin is fitted within an axial hole 30 in the table 3. The ring seal 90 has a dual-lip shape having lips protruding upwardly and downwardly from the inner peripheral surface thereof. These lips are intimately contacted with the outer peripheral surface of the center shaft 5 and are curved in such directions that they are gradually separated from each other with decreasing distance from the center shaft 5. Accordingly, during both pressurizing and depressurizing, it is possible to prevent air from passing therethrough. Further, the ring seal 90 is made of a fluororesin and, thus, has excellent chemical resistance and is less prone to generate dust. Thus, the hermeticity of the table 3 is maintained. Further, the table 3 extends to protrude from the rotation columns 10 and 11 outwardly in the radial direction. Further, when the cover 80 is lowered, the lower end surface of the cover 80 comes into contact with the upper surface of the protruding portion with a rubber O-ring seal 87 interposed therebetween. The O-ring seal 87 is fitted in an annular-shaped concave portion 74 formed in the lower end surface of the cover 80. The cover 80 is provided with switching valves 82 and 85 and an exhaust valve 86. Accordingly, when the cover 80 is lowered to be contacted with the table 3, air is prevented from flowing into and from the space S surrounded by the cover 80 and the table 3.

It is also possible to ensure the hermeticity at the portion where the table 3 and the center shaft 5 are fitted with each other, by using two or more seals, such as a seal with an upper lip (for pressurization) and a seal with a lower lip (for depressurization), instead of using the ring seal 90. As illustrated in a longitudinal cross-sectional view of FIG. 13, an annular concave portion 75 can be formed in the upper surface of a table 3′, instead of the concave portion 74, and an O-ring seal 87 can be fitted therein to enable hermetically contacting the upper surface of the table 3′ with the lower end surface of the cover 80′. Further, the enlarged view of the portion D in FIG. 13 is similar to FIG. 10.

With the aforementioned cleaning apparatus 2, after the rotation of the table 3 is stopped and the cover 80 is lowered to seal the periphery of the substrate 70 with the cover 80 and the table 3, the pressure can be reduced with a vacuum pump 81 through the switching valve 82 for drying the substrate 70. By alternating the sets of the rotation columns 10 and 11 which support the substrate 70, it is possible to dry the portions contacted with the columns 10 and 11 without moving the substrate 70. Since the depressurization increases the vaporization speed of the cleaning liquid, the substrate 70 is dried at a room temperature. Furthermore, the space S to be depressurized is a small area surrounded by the upper surface of the table 3 and the cover 80 and, therefore, can be rapidly depressurized. This can prevent occurrence of water marks. Furthermore, there is no need for moving the substrate 70 after cleaning, thereby preventing contaminations which would occur during moving. Also, it is possible to introduce, through the switching valve 85, a gas inert to the substrate material and the conductive material, such as nitrogen, and concurrently exhaust air through the exhaust valve 86 while adjusting the pressure with a regulator 84, prior to the depressurization before cleaning, as required. Further, depressurization and drying can be performed after or during the substitution of the nitrogen to fill the trenches with the nitrogen, thereby enabling cleanly drying without oxidizing the conductive material.

What is claimed is:

1. An apparatus for cleaning a substrate by ejecting a cleaning liquid from a nozzle while rotating the substrate, the apparatus comprising:
a main body;
two or more linear reciprocating driving sources mounted to the main body, the driving sources being capable of generating outputs independently of one another;
a rotation shaft rotatably mounted to the main body;
two or more cam mechanisms mounted to the main body rotatably about the rotation shaft, the cam mechanisms being for converting the outputs into rotating forces;
two or more sets of rotation columns having respective axes parallel to the rotation shaft at positions radially spaced from the center of the rotation shaft, the rotation columns being fixed to the rotation shaft rotatably about their respective axes to horizontally support the substrate and sandwich or release the side surface of the substrate in cooperation with one another along with their rotation;
two or more transfer members having a rotation center concentric with the rotation shaft, the transfer members being capable of transferring the rotating force to the sets of rotation columns in conjunction with the cam mechanisms, respectively; and
a stopper secured to the rotation shaft and causing the rotation of the cam mechanisms to be related to the rotation of the rotation shaft.

2. The apparatus according to claim 1, wherein the rotation columns include a column having an upper surface and a pin erected at a decentered position on the upper surface and brought into contact with the side surface of the substrate or separated therefrom along with the rotation of the column, and the pins constituting each set are placed substantially at even intervals in the circumferential direction and are placed at phase positions different from the other sets of pins.

3. The apparatus according to claim 2, wherein the upper surface is inclined and the decentered position is a highest position on the upper surface.

4. The apparatus according to claim 1, wherein gear teeth are formed on the outer peripheral surfaces of the rotation columns and on the outer peripheral surfaces of the transfer members, such that the gear teeth formed on the outer peripheral surfaces of the rotation columns and the gear teeth formed on the outer peripheral surfaces of the transfer members are engageble with each other.

5. The apparatus according to claim 1, wherein the cam mechanisms are constituted by a grooved cam which is mounted rotatably with respect to the main body and movably in the direction of the rotation shaft and has a groove inclined with respect to the rotation shaft, and a roller which rotates within the groove and is mounted to the corresponding transfer member.

6. The apparatus according to claim 5, wherein the stopper is a disk member orthogonal to the rotation shaft and has concave portions which allow the grooved cams to move in the direction of the rotation shaft and cause the grooved cams to rotate together with the rotation shaft.

7. The apparatus according to claim 1, further comprising a table secured to the upper end of the rotation shaft, wherein the rotation columns are hermetically fixed to the rotation shaft through the table.

8. An apparatus for cleaning a substrate by ejecting a cleaning liquid from a nozzle while rotating the substrate, the apparatus comprising:
a main body;
two or more linear reciprocating driving sources mounted to the main body, the driving sources being capable of generating outputs independently of one another;
a rotation shaft rotatably mounted to the main body;
a table secured to the upper end of the rotation shaft;
two or more cam mechanisms mounted to the main body rotatably about the rotation shaft, the cam mechanisms being for converting the outputs into rotating forces;
two or more sets of rotation columns having respective axes parallel to the rotation shaft at positions radially spaced from the center of the rotation shaft, the rotation columns being hermetically fixed to the table rotatably about their respective axes to horizontally support the substrate and sandwich or release the side surface of the substrate in cooperation with one another along with their rotation;
two or more transfer members having a rotation center concentric with the rotation shaft, the transfer members being capable of transferring the rotating force to the sets of rotation columns in conjunction with the cam mechanisms, respectively;
a stopper secured to the rotation shaft and causing the rotation of the cam mechanisms to be related to the rotation of the rotation shaft; and
a cover capable of being hermetically contacted with the upper surface of the table and housing the rotation columns.

9. The apparatus according to claim 8, wherein the rotation shaft has a tubular shape, a center shaft is fitted within the rotation shaft, a cleaning-liquid supply pipe is inserted through the center shaft, the lower end of the center shaft is secured to the main body and the upper end of the center shaft is penetrated through the table while maintaining the hermeticity.

10. The according to claim 1, wherein the transfer members are made of a resin and are in contact with the rotation shaft such that the transfer members are rotatable together with the rotation shaft.

11. The apparatus according to claim 1, wherein the transfer members are made of a metal and are fitted with the rotation shaft through a bearing.
